(19) United States
(12) Patent Application Publication
(10) Pub. No.: US 2010/0012898 A1
(43) Pub. Date: Jan. 21, 2010

(54) METHOD FOR CONTROLLING THE SIZE OF RARE-EARTH-DOPED FLUORIDE NANOPARTICLES

(75) Inventors: CHANGZAI CHI, HOCKESSIN, DE (US); DANIEL ALBERT GREEN, MOYLAN, PA (US); KURT RICHARD MIKESKA, HOCKESSIN, DE (US); PAUL GREGORY BEKIARIAN, WILMINGTON, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/534,267

(22) Filed: Aug. 3, 2009

Related U.S. Application Data
(63) Continuation-in-part of application No. 11/445,528, filed on Jun. 2, 2006.

(51) Int. Cl. C09K 11/61

(52) U.S. Cl. 252/301.4 H

(57) ABSTRACT

A method wherein an aqueous solution of a fluoride, an aqueous solution of a Group 2 or Group 3 metal salt, and an aqueous solution of a rare-earth metal dopant are combined to form a precipitate of a rare-earth doped Group 2 or Group 3 metal fluoride, and wherein increasing the concentration of the rare-earth dopant cation increases the resulting particle size, and wherein decreasing the concentration of the rare-earth dopant cation decreases the particle size.

### PRIOR APPLICATIONS

This application claims priority to application Ser. No. 11/445,528, filed on Jun. 2, 2006 which is herein incorporated by reference.

### FIELD OF THE INVENTION

The present invention provides a method for controlling the size of rare-earth-doped Group 2 or Group 3 metal fluoride nanoparticles formed in an aqueous process.

### BACKGROUND OF THE INVENTION

Several references describing methods for controlling the size of flouride nanoparticles follow. Bender et al., Chem. Mater. 2000, 12, 1969-1076, discloses a process for preparing Nd-doped BaF₂ nanoparticles by reverse microemulsion technology. Bender expressly states that aqueous salt solutions such as 0.06 M Ba⁺², produce particles smaller than 100 nm while concentrations of about 0.3 M Ba⁺² resulting in particles larger than 100 nm. Luminescing particles are disclosed. Bender discloses a decrease in lattice parameter for BaF₂ nanoparticles doped with Nd.

Wang et al., Solid State Communications 133 (2005), 775-779, discloses a process for preparing 15-20 nm Eu-doped CaF₂ particles in ethanol. Wang expressly teaches away from employing an aqueous reaction medium.

Wu et al., Mat. Res. Soc. Symp. Proc. 286, 27-32 (1993) disclose that CaF₂ particles produced by a vapor phase condensation process are characterized by an average particle size of 16 nm while Ca_{0.75}La_{0.25}F_{2.25} particles prepared by the same process were characterized by average diameter of 11 nm.

Stouwdam et al., Nano Lett. 2(7) (2002), 733-737, discloses synthesis of rare-earth-doped LaF₃ in ethanol/water solution incorporating a surfactant to control particle size. The resultant produced incorporates the surfactant. 5-10 nm particles are prepared.

Haubold et al., U.S. Patent Publication 2003/0032192, discloses a broad range of doped fluoride compositions prepared employing organic solutions at temperatures in the range of 200-250° C. 30 nm particles are disclosed. The organic solvent employed degrades and acts as a particle-size controlling surfactant.

Knowles-van Cappellen et al., Geochim. Cosmochim. Acta 61(9) 1871-1877 (1997), discloses preparation of 214±21 nm particles by combining in aqueous solution equal volumes of 0.1 M Ca(NO₃)₂ and 0.2 M of NaF. Knowles-van Cappellen is silent regarding doped particles.

The references teach methods for preparation of multi-valent fluorides, doped and undoped, with particle sizes in the range of about 2 to 500 nm. The teachings are confined to non-aqueous reaction media, or water/alcohol. The methods teach various means for controlling the particle size produced. For example, Bender teaches that higher concentrations of reactants lead to larger particles. Others show that the presence of a rare-earth dopant decreases particle size. Still others, Stouwdam, op. cit., and Haubold, op. cit., employ surfactants to control particle size.

It is desirable to have a method for controlling the size of metal fluoride nanoparticles precipitated from aqueous solution.

### SUMMARY OF THE INVENTION

A method comprising
preparing a plurality of reactive precipitations wherein each reactive precipitation comprises combining
a first aqueous solution of a fluoride selected from the group consisting of alkali metal fluorides, ammonium fluoride, hydrogen fluoride, and mixtures thereof at a concentration in the range of 0.1 normal to 3 normal;
a second aqueous solution of a Group 2 or Group 3 metal salt comprising a Group 2 or Group 3 metal cation at a concentration in the range of 0.1 normal to 3 normal; and,
a third aqueous solution of a rare-earth metal dopant salt comprising a a rare-earth metal dopant cation wherein the concentration of the rare-earth metal cation is in the range of 0.5 to 25 mol-% of the molar concentration of said Group 2 or Group 3 metal cation; and, wherein the concentration of the rare-earth metal dopant cation is in the range of 0.0005 to 0.75 normal with respect to the combined volumes of the second and third aqueous solutions;
   thereby,
   forming a precipitate of a rare-earth doped aqueously insoluble Group 2 or Group 3 metal fluoride characterized by an average equivalent spherical diameter in the range of 2 to 200 nm and a rare-earth dopant concentration of 0.5 to 25 mol-%, with respect to the concentration of said Group 2 or Group 3 metal, said aqueously insoluble fluoride being characterized by an aqueous solubility of less than 0.1 g/100 g of water; and,

wherein each reactive precipitation differs from the others by the concentration of the rare-earth metal dopant cation with respect to the combined volumes of the second and third aqueous solutions,

thereby determining the dependency of the average equivalent spherical diameter of the nanoscale rare-earth-doped Group 2 or Group 3 metal fluoride on the concentration of the rare-earth metal dopant cation; and,
preparing at least one additional the reactive precipitation at a rare-earth-dopant concentration selected to provide a desired particle size.

In another aspect, the present invention provides a method comprising mutually contacting a plurality of continuous feed streams thereby combining them into a single discharge stream and discharging the discharge stream into a product receiving vessel;
wherein, the plurality of feed streams comprises
a first feed stream comprising a first aqueous solution of a fluoride selected from the group consisting of alkali metal fluorides, ammonium fluoride, hydrogen fluoride, and mixtures thereof at a concentration in the range of 0.1 normal to 3 normal;
a second feed stream comprising a second aqueous solution of a Group 2 or Group 3 metal salt comprising a Group 2 or Group 3 metal cation at a concentration in the range of 0.1 normal to 3 normal; and,
a third feed stream comprising a third aqueous solution of a salt of a rare-earth metal dopant wherein the absolute amount of the rare-earth is in the range of 0.5 to 25 mol-% of the molar concentration of said Group 2 or Group 3 metal cation;
wherein the second and third aqueous solutions can optionally be combined into a single feed stream before contacting with the first feed stream;
   thereby forming a precipitate of an aqueously insoluble rare-earth doped Group 2 or Group 3 metal fluoride characterized by d50 particle size in the range of 2 to 200 nm and a dopant concentration of 0.5 to 25 mol-%, the rare-earth doped Group 2 or Group 3 metal fluoride being characterized by an aqueous solubility of less than 0.1 g/100 g of water;
   and,
   wherein the concentration of the rare earth metal cation in the combined feed streams falls in a range above that of the threshold concentration range for particle size sensitivity to rare-earth metal cation concentration.

### BRIEF DESCRIPTION OF THE DRAWINGS

FIG. 1 is an optical micrograph of the CaF₂ particles prepared in Comparative Example A-1

FIG. 2 is a transmission electron micrograph of the CaF₂ particles prepared in Comparative Example A-2.

FIG. 3 is a transmission electron micrograph of the CaF₂ particles prepared in Comparative Example A-3.

FIG. 4 is a graphical representation of the particle size dependency on the concentration of Ca²⁺ described in Comparative Example A.

FIG. 5 is a graphical representation of the particle size dependency on the concentration of Tb³⁺ described in Example 1.

FIG. 6 shows a schematic representation of the two-channel continuous flow reactor that was employed in Examples 2-8.

FIG. 7 is a graphical representation of the particle size dependency on La³⁺ described in Example 2.

FIG. 8 is a graphical representation of the particle size dependency on La³⁺ described in Example 3.

### DETAILED DESCRIPTION

Nanoparticles of rare-earth-doped Group 2 and Group 3 fluorides have broad utility in many fields where the small size reduces light scattering and haze. The luminescent particles are useful for the formation of lasers, optical displays, and optical amplifiers. The present invention is directed to controlling the size of the nanoscale particles.

For the purposes of the present invention, the term “nanoparticles” shall be understood to refer to an ensemble of particles wherein at least 50% of the particles on a volume basis (designated “d50”) are smaller than or equal to 200 nm in their largest dimension. When the particle size is determined by light scattering, “nanoparticles” shall be understood to mean that the average equivalent spherical diameter (AESD) of the particles lies in the range from 2 to 200 nm. For the purposes of the present invention, when the term “particle size” is employed, it shall be understood to refer to average equivalent spherical diameter unless otherwise stated.

For the purposes of the present invention, when a range of numerical values is provided, it shall be understood that the end points of the stated range are included therein, unless specifically stated to be otherwise.

The term “Group 2 or Group 3 metal cation” refers to a cation formed from a metal listed in the periodic table of the elements under Group 2 or Group 3, including the lanthanide series. According to the process hereof, an aqueous solution of a Group 2 or Group 3 metal salt, an aqueous solution of a rare-earth metal salt, and an aqueous solution of a fluoride salt are combined to form a precipitate of nanoscale particles comprising an aqueously highly insoluble rare-earth doped Group 2 or Group 3 metal fluoride compound. The term “Group 2 or Group 3 metal fluoride” refers to the fluoride salt formed between the Group 2 or Group 3 metal cation and fluoride. “Group 2 or Group 3 salt” refers to an aqueously soluble starting salt of the process hereof; the cationic moiety thereof being the Group 2 or Group 3 metal cation defined supra. The term “rare-earth” refers to the members of the Lanthanide Series in the periodic table, namely La, Ce, Pr, Nd, Pm, Sm, Eu, Gd, Tb, Dy, Ho, Er, Tm, Yb, and Lu. The term “rare-earth dopant salt” refers to an aqueously soluble starting salt of the process hereof. The term “fluoride salt” refers to an aqueously soluble starting salt of the process hereof.

For the purposes of the present invention, the term “Group 2 or Group 3 metal fluoride” refers to the so-called host compound, into the crystalline lattice of which the dopant hereof is inserted. Some rare-earth species, such as Lanthanum, are suitable for use both as the host and as the dopant. Other rare-earth species are suitable for use only as dopants.

According to the present invention, an aqueous solution of a Group 2 or Group 3 metal salt, an aqueous solution of a rare-earth dopant salt, and an aqueous solution of a fluoride salt are combined to form a highly insoluble rare-earth-doped Group 2 or Group 3 metal cation fluoride in the form of nanoscale particles. Although the invention is described in terms of “a” salt of each type of reagent, the invention encompasses mixed salts of each. So, for example while “a fluoride salt” is referred to, it shall be understood that a mixture of fluoride salts is also suitable. Similar understanding is extended to the terms “a Group 2 or Group 3 metal salt” and “a rare-earth dopant salt.”

According to the process, aqueous solutions of an aqueously soluble fluoride, an aqueously soluble Group 2 or Group 3 metal salt, and an aqueously soluble rare-earth dopant salt are combined at room temperature to produce a highly insoluble rare-earth-doped Group 2 or Group 3 metal fluoride in the form of nanoscale particles. The reaction in aqueous solution of the soluble fluoride with the soluble Group 2 or Group 3 metal cation is virtually instantaneous. The low solubility of the rare-earth-doped Group 2 or Group 3 metal fluoride hereby prepared ensures that precipitation occurs so quickly in the process of the invention that there is little time for crystal growth before precipitation. The rare-earth-doped Group 2 or Group 3 metal fluorides produced by the method hereof are characterized by an aqueous solubility of less than 0.1 g/100 g of water and a particle size in the range of 2 to 200 nm.

The present invention discloses a novel method for controlling the particle size of rare-earth-doped Group 2 or Group 3 metal fluoride nanoparticles in the size range of 2 to 200 nm that are prepared in a completely aqueous process. The invention provides a method for determining the dependency of particle size (expressed as AESD) on the concentration of the rare earth dopant cation with respect to the combined volumes of the second and third aqueous solutions. The specifics of the dependency will depend upon the particular combination of reagents, reaction conditions, and apparatus involved. Once the dependency is determined, the particle size of subsequent reactive precipitations can be selected by choosing to employ the corresponding rare-earth-dopant cation concentration As shown in the Examples, infra, particle size exhibits much higher sensitivity, expressed in nm/mol, to changes in rare-earth dopant cation concentration in the feed solution than it does to changes in Group 2 or Group 3 metal concentration.

The term “feed solution” refers to the aqueous solutions prepared respectively from the Group 2 or Group 3 metal salt, the rare-earth dopant salt, and the fluoride salt. In the practice of the invention, the Group 2 or Group 3 metal salt and rare-earth dopant salt may be combined into a single solution before combining with the fluoride solution.

For the purposes of the present invention particle size sensitivity to concentration is expressed as the absolute value of the slope of the particle size vs. concentration curve; that is |Δsize/Δconcentration|. In the examples, infra, the slope is conveniently estimated as the slope of the straight line connecting two adjacent data points.

Accordingly, an aqueous solution of a fluoride selected from the group consisting of alkali metal fluorides, ammonium fluoride, hydrogen fluoride, and mixtures thereof at a concentration in the range of 0.1 normal to 3 normal is combined with an aqueous solution of a Group 2 or Group 3 metal salt, consisting essentially of a Group 2 or Group 3 metal cation and an anion, at a concentration in the range of 0.1 to 3 normal, and an aqueously soluble rare-earth dopant salt at a concentration such that the molar ratio of rare-earth dopant cation concentration to Group 2 or Group 3 metal cation concentration lies in the range of 0.005 to 0.25 (0.5 to 25 mol-%). The particles thereby formed are rare-earth-doped Group 2 or Group 3 metal fluorides characterized by a particle size such that the AESD thereof lies in the range of 2 to 200 nm.

The actual value of AESD which will be realized for any given concentration of starting ingredients depends upon numerous specific reaction ingredients and conditions. Factors which affect the particle size at a fixed concentration level include but are not limited to: the chemical identity of the reactants, the presence and concentration of dopant, the solubility of the Group 2 or Group 3 metal fluoride, the flow rates of the feed streams in a continuous process, and the method of product separation.

In the process hereof, it is preferred to combine the fluoride and the Group 2 or Group 3 metal and dopant cations in stoichiometric concentration. However, exact stoichiometric conditions are not required.

In one embodiment, the overall cationic concentration is held constant but the molar ratio of rare-earth cation concentration to the Group 2 or Group 3 metal cation concentration is altered. In practice, when the practitioner hereof starts with a particular combination of ingredients in a particular apparatus, a plurality of reactive precipitations is performed, each reactive precipitation differing from the other members by the concentration of rare-earth dopant cation in the starting salt solution. The plurality of reactive precipitations will determine the concentration-dependence of average particle size of the rare-earth doped Group 2 or Group 3 metal fluoride on the concentration of the rare-earth cation, thereby allowing the practitioner hereof to adjust the average particle size to the desired value. The range of concentrations over which the rare-earth dopant cation can be varied is from 0.0005 normal to 0.75 normal with respect to the combined volumes of the second and third aqueous solutions.

Any Group 2 or Group 3 metal salt can be employed in the process with the proviso that the corresponding Group 2 or Group 3 metal fluoride produced hereby is characterized by an aqueous solubility of less than 0.1 g/100 g at room temperature. Aqueous solubilities of inorganic fluorides are available from a number of sources, including the well-known CRC Handbook of Chemistry and Physics, 8^{th} Edition. Fluorides which as are listed as having solubility below 0.1 g/100 g water or indicated to be “insoluble” in water are suitable for employment in the method of the invention. Many rare-earth fluorides are soluble in water, and are therefore not suitable for use as the Group 2 or Group 3 metal cation, although all the rare-earth metal cations are suitable for use as dopants.

Group 2 or Group 3 metal cations suitable for use in the present invention include Ca⁺², Mg⁺², Sr⁺², Y⁺³, La⁺³, Ac⁺³, Cr⁺³, Mo⁺³, Ir⁺³, Cu⁺², Ga⁺³ and Pb⁺², as well as the rare-earths Ce⁺³, Nd⁺³, Eu⁺³, Er⁺³, Yb⁺³, and Lu⁺³. Rare-earths are frequently employed as dopants in the art, and the numerous Group 2 or Group 3 metal fluorides prepared according to the process hereof may be subject to doping by incorporating a soluble rare-earth dopant salt into the reaction mixture. However, the rare-earths recited above are not dopants but serve as alternative Group 2 or Group 3 metal cations, subject to the limitations of the process, namely that the resulting rare-earth fluoride salt must have a solubility less than 0.1 g/100 ml of water. While all rare-earths are suitable to use as dopants, only those recited above are suitable to use as the Group 2 or Group 3 metal cations in the method of the present invention.

Preferred anions for the soluble Group 2 or Group 3 metal salt are chloride, nitrate, sulphate, acetate, hydroxide, phosphate, carbonate, and bromide. Preferably the aqueously soluble fluoride is NaF, KF, or NH₄F, most preferably NH₄F. Preferably, the Group 2 or Group 3 metal cation is Ca⁺² in the form of CaCl₂, Ca(NO₃)₂, or CaSO₄. In one embodiment, the concentration of Ca⁺² is in the range of 0.76 to 1.6 normal, and the concentration of fluoride is 0.76 to 1.6 normal. Preferably the reactants are combined in stoichiometric quantities.

It is observed in the practice of the invention, that use of an alkali metal fluoride in combination with certain Group 2 or Group 3 metal cations may result in a mixture of fluorides. This problem can be remedied by employing NH₄⁺ in place of an alkali metal in the process. For that reason NH₄F is a preferred starting material if there is any question about undesirably contaminating the pure Group 2 or Group 3 metal fluoride with the alkali-containing contaminant.

The soluble salt starting materials need only be soluble enough to form aqueous solutions of the desired concentrations for the purposes of the present invention. From the standpoint of the present invention, a salt is said to be aqueously soluble if a solution of the desired concentration can be formed from it.

In one embodiment, the process hereof is a batch process In the typical practice of the batch process of the invention, the ingredients are combined together in aqueous solution in the space of a few minutes, and then allowed to react while being stirred for about 30 minutes. Stirring is not critical once precipitation has finished. Particle size uniformity is improved therewith. The pH of the reaction mixture is preferably maintained close to neutral but a pH range from about 1-11 is acceptable.

In one embodiment, the process hereof is a continuous process wherein the rare-earth dopant and Group 2 or Group 3 metal salts are combined to form a first continuous feed stream and the soluble fluoride solution forms a second continuous feed stream. The two feed streams are fed continuously and simultaneously to a mixing chamber where the streams directly impinge on each other to combine and mix, preferably while being ultrasonically agitated, at constant temperature followed by discharge of the nano-particle suspension formed thereby to a product receiving vessel.

Residual soluble inorganic salts are removed from the thus formed nano-particle suspension by any means conventionally employed in the art for separating soluble salts from a fine particle suspension. Dispersing in water followed by centrifugation is one effective method. Dialysis or ion exchange are useful alternatives to centrifugation. Dialysis is highly effective at keeping the particles dispersed while removing residual soluble salts. By avoiding the compaction associated with centrifugation, the smallest possible particle size is maintained. Purification by dialysis is preferred.

Suitable dialysis membrane tubing known to the art include but are not limited to those made from regenerated cellulose or cellulose esters that are commercially available under brand names such as Spectra Por™ Molecular Porous Membrane Tubing sold by Spectrum Laboratories. Suitable are membranes having a molecular weight cut-off (MWCO) of 1,000-50,000 Da are suitable for the removal of soluble salts from the nano-particle suspensions prepared in the process of the invention. A MWCO of 10,000-20,000 Da is preferred.

In one embodiment, the nano-particle suspensions are sealed within the dialysis membrane tubing and immersed in a reservoir of deionized water to allow the soluble salts to pass from the nano-particle suspension through the membrane and into the reservoir while the nano-particles are confined to the interior of the dialysis membrane tubing where they remain suspended without compaction. The water in the reservoir is replaced with fresh deionized water either continuously or at intervals to facilitate removal of the soluble salts from the nano-particle suspension prepared in the process of the invention. The dialysis can be conducted at any temperature within the tolerances of the dialysis membrane tubing but it is preferred to conduct the dialysis at ambient temperature. The dialysis process can be deemed complete at the discretion of the practitioner. It is preferred that the dialysis be continued until the ionic conductivity of the nano-particle suspension within the dialysis membrane tubing has decreased to a constant value.

Other suitable methods of separating the precipitate from aqueous salt by-products include ion exchange, ultrafiltration and electrodialysis. Methods for concentrating or drying the precipitated fluoride include evaporation of water, centrifugation, ultrafiltration, and electrodecantation. In one embodiment, ion exchange resins remove soluble salt residues followed by evaporation to concentrate the colloidal sol produced in the process.

For dispersion in non-polar solvents, it may be required to combine the particles produced by the process with surfactants, as taught in the art.

In the process of the present invention it is preferred to combine the rare-earth dopant salt and the Group 2 or Group 3 metal salt before combining with the fluoride. The combination of the mixed salts with the fluoride may be effected by slowly adding the mixed salt solutions to the fluoride solution over period of several minutes, or rapidly combining the solutions, in less than a minute. The combination may be effected in a vessel, or it may be effected on a continuous feed basis to a mixing chamber. Any difference in result attributable to whether the dopant rare-earth and Group 2 or Group 3 metal mixed salt solution is added to the fluoride solution, or the fluoride solution is added to the mixed salt solution appears to be negligible.

In another aspect, the present invention provides a method for preparing a rare-earth doped Group 2 or Group 3 metal fluoride in a continuous process in the form of nanoparticles with minimized particle size variability, the method comprising preparing a series of rare-earth doped Group 2 or Group 3 metal fluorides, said series comprising a plurality of members thereof, wherein the members are characterized by equal total cation molarity, but differ one from another by the molar ratio of rare-earth cation to Group 2 or Group 3 cation; determining the particle size of a sufficient number of said members to identify the threshold concentration region of rare-earth dopant; and, operating said continuous process at a rare-earth dopant concentration above said threshold concentration region;
each said member being prepared by
combining a first aqueous solution of a fluoride selected from the group consisting of alkali metal fluorides, ammonium fluoride, hydrogen fluoride, and mixtures thereof at a concentration in the range of 0.1 normal to 3 normal;
a second aqueous solution of a Group 2 or Group 3 metal salt comprising a Group 2 or Group 3 metal cation at a concentration in the range of 0.1 normal to 3 normal; and,
a third aqueous solution of a salt of a rare-earth metal dopant wherein the absolute amount of the rare-earth is in the range of 0.5 to 25 mol-% of the molar concentration of said Group 2 or Group 3 metal cation; and
forming a precipitate of an aqueously insoluble Group 2 or Group 3 metal fluoride characterized by d50 particle size in the range of 2 to 200 nm and a dopant concentration of 0.5 to 25 mol-%, said Group 2 or Group 3 metal fluoride being characterized by an aqueous solubility of less than 0.1 g/100 g of water.

It is shown in the Examples infra that the particle size of the rare-earth doped Group 2 or Group 3 metal fluoride prepared according to the process herein exhibits high sensitivity to the concentration of the rare-earth cation in the feed stream of the continuous process described supra. It is further shown that the sensitivity is highest at the lowest concentrations of rare-earth cation, and that, furthermore, there appears to exist a threshold concentration above which the sensitivity of particle size to rare-earth concentration decreases by an order of magnitude.

One goal of a production process is product uniformity. It is understood that in real world production processes some fluctuations will occur, and the effect of these fluctuations determines the product release tolerances. Thus any method that permits tighter tolerances is highly desirable.

In the present invention, the method provides for the preparation of a plurality of test specimens aimed at defining the dependence of particle size on rare-earth cation concentration in order to identify the threshold concentration. Once the threshold concentration region is identified, the process is run at concentrations above the threshold concentration region in order to minimize the effect of concentration fluctuations on particle size. The test specimens are prepared according to the process outlined supra and in accordance with the Examples presented infra.

In another aspect, the invention provides a process comprising mutually contacting a plurality of continuous feed streams thereby combining them into a single discharge stream and discharging the discharge stream into a product receiving vessel;
wherein, the plurality of feed streams comprises
a first feed stream comprising a first aqueous solution of a fluoride selected from the group consisting of alkali metal fluorides, ammonium fluoride, hydrogen fluoride, and mixtures thereof at a concentration in the range of 0.1 normal to 3 normal;
a second feed stream comprising a second aqueous solution of a Group 2 or Group 3 metal salt comprising a Group 2 or Group 3 metal cation at a concentration in the range of 0.1 normal to 3 normal; and,
a third feed stream comprising a third aqueous solution of a salt of a rare-earth metal dopant wherein the absolute amount of the rare-earth is in the range of 0.5 to 25 mol-% of the molar concentration of said Group 2 or Group 3 metal cation;
wherein the second and third aqueous solutions can optionally be combined into a single feed stream before contacting with the first feed stream;
   thereby forming a precipitate of an aqueously insoluble rare-earth doped Group 2 or Group 3 metal fluoride characterized by d50 particle size in the range of 2 to 200 nm and a dopant concentration of 0.5 to 25 mol-%, said rare-earth doped Group 2 or Group 3 metal fluoride being characterized by an aqueous solubility of less than 0.1 g/100 g of water;
   and,
   wherein the concentration of the rare earth metal cation in the combined feed streams falls in a range above that of the threshold concentration range for particle size sensitivity to rare-earth metal cation concentration.

It is apparent from the graphical representations of the dependency of particle size on rare-earth cation concentration in the feed stream that a threshold concentration region exists in which the rate of decrease of particle size (that is, the “sensitivity” expressed in nm/mol) with increasing concentration decreases dramatically. For the purposes of the present invention, it is not necessary to precisely determine the threshold concentration region, only to operate the process at a rare-earth cation concentration that lies above the threshold concentration region.

The practice of the invention is further described in but not limited to the following specific embodiments.

### EXAMPLES

### Comparative Example A and Examples 1

NaF was obtained in solid form from J. T. Baker Reagents. CaCl₂.2H₂O was obtained from EM Sciences. All other reagents were obtained from Aldrich Chemical Company.

### Comparative Example A

Particle size dependence on Ca⁺² ion concentration was determined at three concentration points, as follows

### Comparative Example A-1

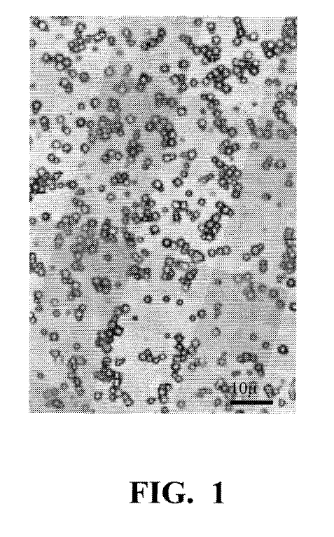

45 ml of 0.02 M NaF aqueous solution was added to a 250 ml polycarbonate flask. The solution was stirred using a magnetic stirring bar. 50 ml of 0.01 M CaCl₂ was added to the NaF with vigorous stirring. The mixture was stirred for 10 min. Precipitation was observed. A small amount of precipitate was examined using a Nikon Optical Microscope equipped with a digital camera. The crystal size of CaF₂ particle was in the range of 1˜3 micrometers as shown in FIG. 1. D50 was clearly greater than 500 nm by visual evaluation of the photomicrograph.

### Comparative Example A-2

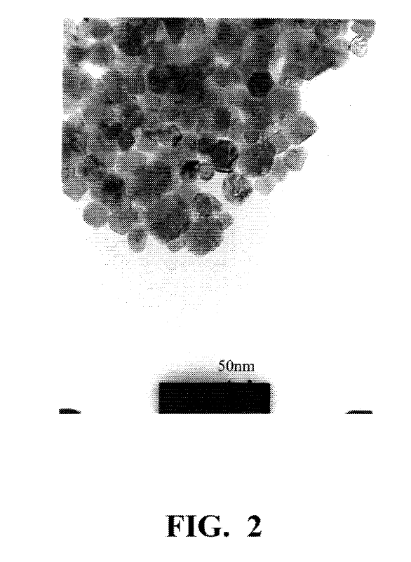

45 ml of 0.2 M NaF aqueous solution was added to a 250 ml polycarbonate flask. The solution was stirred using a magnetic stirring bar. Into the same flask, 50 ml of 0.1 M CaCl₂ was added to the NaF with vigorous stirring. A CaF₂ colloidal sol was formed. The mixture was stirred for 30 min. A small amount of the colloidal suspension was then diluted with de-ionized water and analyzed by transmission electron microscopy (TEM). The TEM image showed the crystal size of the CaF₂ particles prepared in this example is in the range of 50˜200 nm (FIG. 2). By visual inspection of the electron micrograph, d50 was estimated to be in the range of 100-150 nm.

### Comparative Example A-3

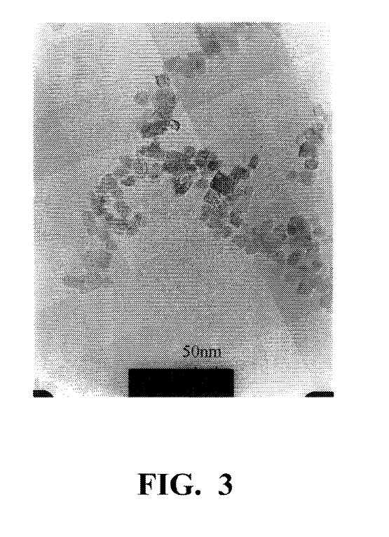

50 ml of 0.8 M NaF aqueous solution was added to a 250 ml polycarbonate flask. The solution was stirred using a magnetic stirring bar. 50 ml of 0.4 M CaCl₂ was added to the NaF with vigorous stirring. The addition was completed in three minutes. A CaF₂ colloidal sol was formed. The sol was stirred for 30 min. A small amount of the colloidal sol was diluted 30 times with de-ionized water and analyzed by TEM. The TEM image showed that the crystal size of the CaF₂ nanoparticles thus prepared were in the range of 20˜70 nm (FIG. 3). By visual inspection of the electron micrograph, d50 was estimated to be 45 nm.

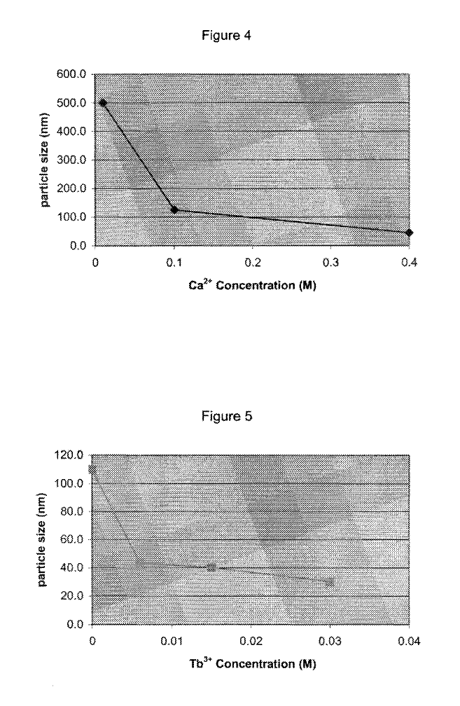

Results are summarized in Table 1 and shown in graphical form in FIG. 5. Also shown in Table 1 are the slopes of the lines connecting adjacent points on the graph shown in FIG. 4.

TABLE 1

| | Ca2+ | Average | |
|---|---|---|---|
| Comparative | concentration | Size-d50 | Sensitivity |
| Example | (M) | (nm) | (nm/mol-Ca²⁺) |
| A-1 | 0.01 | 500.0 | |
| A-2 | 0.1 | 125.0 | 4167 |
| A-3 | 0.4 | 45.0 | 267 |

### Example 1

Particle size dependence on Tb³⁺ ion concentration was determined at four concentration points, while overall cationic molar concentration was maintained constant, as follows

0.3 M CaCl₂ solution was mixed with 0.3 M TbCl₃ solution in a 250 ml polycarbonate flask, in the amounts shown in Table 2. The thus mixed solution was then poured with vigorous stirring into a 500 ml polycarbonate flask containing 0.6 M NaF solution.

TABLE 2

| | | 0.3 M CaCl₂ | 0.3 M TbCl₃ | 0.6 M NaF |
|---|---|---|---|---|
| | | solution | solution | solution |
| | Tb % | (ml) | (ml) | (ml) |
| Ex. 1-1 | 0 | 80 | 0 | 80 |
| Ex. 1-2 | 2 | 98 | 2 | 101 |
| Ex. 1-3 | 5 | 95 | 5 | 102.5 |
| Ex. 1-4 | 10 | 90 | 10 | 105 |

The addition of the metal chloride solutions into the sodium fluoride solution was completed in 30˜60 seconds. The resulting colloidal suspension was stirred for 2 min followed by ultrasonic agitation for 30 min using a Branson 1510 ultrasonic bath. The colloidal sols were aged for 2˜3 hr and then centrifuged at 7500 rpm for 35 min. The supernatant liquid was decanted. The residual wet cake was then divided into two parts.

Half of the wet cake was transferred into a 50 ml plastic tube. Deionized water was added to make up a final volume of 45 ml. The mixture was then ultrasonically agitated with a micro-tip unltrasonic probe (VibraCell, Sonics & Material, Danbury, Conn., USA) for 3 min. The cake was dispersed into a translucent dispersion that appeared to the eye to be homogeneous in de-ionized water after sonication. Particle size distribution of the resulting dispersed sol was determined by dynamic light scattering using a Zetasizer® Nano-S. Just prior to measurement, each specimen was subject to additional ultrasonic agitation for 2 min using the egular-tip (half inch) ultrasonic probe of the VibraCell®.

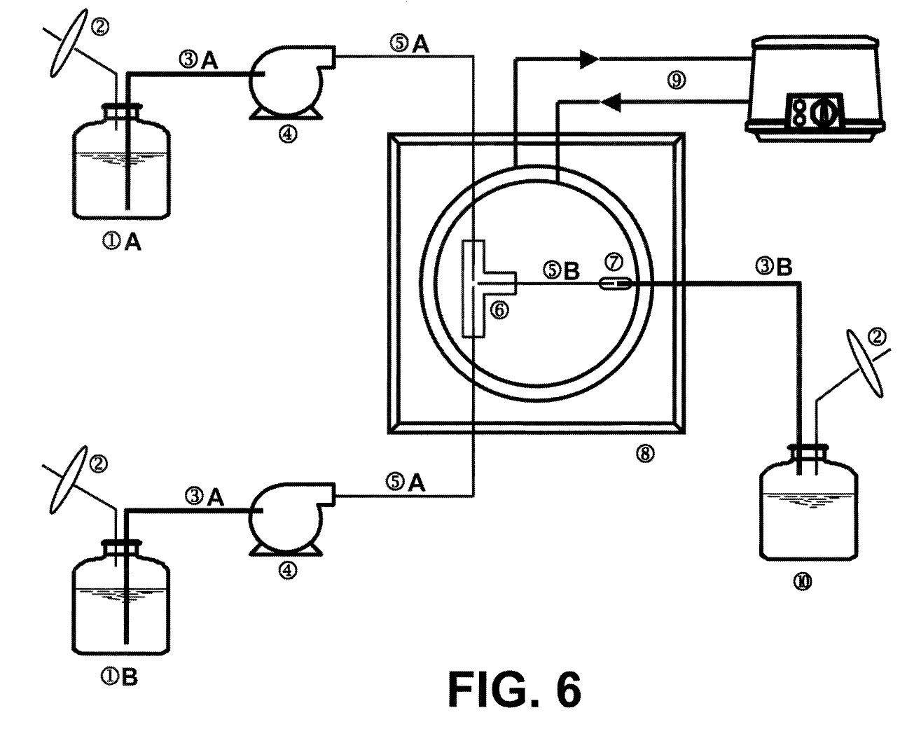

Results are summarized in Table 3 and shown in graphical form in FIG. 6. Also shown in Table 3 are the slopes of the lines connecting adjacent points on the graph shown in FIG. 5.

TABLE 3

| | | Ca2+ | Tb3+ | | Sensitivity |
|---|---|---|---|---|---|
| | | concentration | concentration | AESD | (nm/mol- |
| Example | Tb % | (M) | (M) | (nm) | Tb³⁺) |
| 1-1 | 0 | 0.3 | 0 | 109.9 | |
| 1-2 | 2% | 0.294 | 0.006 | 43.4 | 11083 |
| 1-3 | 5% | 0.285 | 0.015 | 40.2 | 356 |
| 1-4 | 10% | 0.27 | 0.03 | 30.2 | 667 |

### Examples 2-5 and Comparative Example B

In the following examples a continuous two feed flow system was employed. FIG. 6 depicts the system. A dual channel Masterflex™ peristaltic pump [4] was equipped with #16 C-Flex™ tubing. Polyethylene tubing (¼ inch OD, ⅛ inch ID) [3A] was attached to the C-Flex tubing on the back side (feed side) of the pump as the main line tubing that would transport the Ca(NO₃)₂ or combined Ca(NO₃)₂ and rare-earth nitrate solution first feed stream, and ammonium fluoride solution second feed stream from reservoirs 1A and 1B respectively. Polyethylene tubing (⅛ inch OD, 1/16 inch ID) [5A] was attached to the C-Flex tubing on the front side (effluent side) of the pump as the main line feed tubing that would transport the feed streams solutions to the 1/16th inch ID plastic T-mixer [6]. The feed streams were directed respectively into opposite ends of the T so that they would intersect each other at an angle of 180 degrees. The product output of the T-mixer was directed out at 90° from the feed streams and carried through approximately 4 inches of polyethylene tubing (⅛ inch OD, 1/16 inch ID) [5B] into a polyethylene union (⅛ inch to ¼ inch) [7] then through polyethylene tubing (¼ inch OD, ⅛ inch ID) [3B] into a clean product receiving bottle [10]. The product receiving bottle was equipped with 0.2μ membrane gas filters [2] on the vent to keep out extraneous dust. The reactor assembly, comprising approximately 3 inches of feed tubing [5A], the T-mixer [6], the 4 inches of effluent tubing [5B] and the ⅛ inch to ¼ inch union [7], was immersed in the cavity of a VWR™ Model 250D Ultrasonic bath [8]. A copper cooling coil (⅜ inch OD, 44 inch length) attached to a Neslab™ Model RTE-7 chiller [9] was suspended in the ultrasonic bath to maintain temperature.

### General Experimental Procedures

### Preparation of Reagents

The calcium, lanthanum, and europium nitrates were purchased as the hydrates from the Aldrich Chemical Company.

Anhydrous ammonium fluoride was also purchased from the Aldrich Chemical Company. The as-received reagents were put under static vacuum (<1 torr) on a vacuum line for 20 hr at ambient temperature to remove adsorbed water. All aqueous solutions were prepared using 18.0 MOhm deionized water obtained from a Barnstead NanoPure™ model D4741 water purifier and filtered 0.2μ at the point of delivery.

The Ca(NO₃)₂ and any rare-earth nitrate were combined in a single solution before feeding into the reaction system. Each soluble cation solution of a given concentration was prepared by combining the quantities of Ca(NO₃)₂ and any rare-earth nitrate as specified in Table 4, with deionized water in a 1000 ml volumetric flask to dissolve the solids and then diluting to a total solution volume of 1000 ml.

Each soluble fluoride solution of a given concentration was prepared by combining the quantity of NH₄F as specified in Table 5, with deionized water in a 1000 ml volumetric flask to dissolve the solids and then diluting to a total solution volume of 1000 ml.

The so-prepared solutions were then filtered through 0.22μ cellulose acetate membranes into separate polycarbonate reservoirs [1] and capped. The feed solution reservoir caps were equipped with 0.2μ membrane gas filters [2] on the vents to keep out extraneous dust. In Table 4, the term “rare earth mole %” refers to the mole fraction of rare earth cation vs. the combined Ca⁺² cation plus rare earth cation.

TABLE 4

| | rare | | | | | | | |
|---|---|---|---|---|---|---|---|---|
| | earth | Ca(NO₃)₂•4H₂O | | La(NO₃)₃•6H₂O | | Eu(NO₃)₃•6H₂O | | for |
| solution | mole % | molarity | grams | molarity | grams | molarity | grams | example |
| S-1 | 0 | 0.2 | 47.2 | | | | | BCD-1 |
| S-2 | 0 | 0.4 | 94.46 | | | | | 4-1, 5-1, |
| | | | | | | | | BCD-2 |
| S-3 | 0 | 0.8 | 188.92 | | | | | 2-1, 3-1 |
| | | | | | | | | BCD-3 |
| S-4 | 0 | 1.2 | 283.38 | | | | | BCD-4 |
| S-5 | 5.0 | 0.38 | 89.74 | 0.02 | 8.66 | | | 7 |
| S-6 | 4.76 | 0.4 | 94.46 | 0.02 | 8.66 | | | 6, 8 |
| S-7 | 5.0 | 0.76 | 179.47 | 0.04 | 17.32 | | | 2-5, 3-5 |
| S-8 | 2.5 | 0.78 | 184.2 | 0.02 | 8.66 | | | 2-4, 3-4 |
| S-9 | 1.0 | 0.792 | 187.03 | 0.008 | 3.46 | | | 2-3, 3-3 |
| S-10 | 0.5 | 0.796 | 187.98 | 0.004 | 1.73 | | | 2-2, 3-2 |
| S-11 | 5.0 | 0.38 | 89.74 | | | 0.02 | 8.92 | 4-2, 5-2 |

TABLE 5

| | |
|---|---|
| NH₄F | for |

| solution | molarity | grams | example |
|---|---|---|---|
| S-12 | 0.4 | 14.8 | BCD-1 |
| S-13 | 0.8 | 29.64 | 4-1, 5-1, 6 |
| | | | BCD-2 |
| S-14 | 0.82 | 30.4 | 4-2, 5-2, 7 |
| S-15 | 0.92 | 34.08 | 8 |
| S-16 | 1.6 | 59.26 | 2-1, 3-1 |
| | | | BCD-3 |
| S-17 | 1.604 | 59.41 | 2-2, 3-2 |
| S-18 | 1.608 | 59.56 | 2-3, 3-3 |
| S-19 | 1.62 | 60.0 | 2-4, 3-4 |
| S-20 | 1.64 | 60.75 | 2-5, 3-5 |
| S-21 | 2.4 | 88.90 | BCD-4 |

### Product Preparation

Prior to starting the reaction the pumping system was first primed and purged by flushing filtered deionized water through the lines. The back-side feed lines were then immersed in the respective feed solutions in their respective reservoirs. The ultrasonic cleaning bath and Neslab chiller were turned on, and the chiller adjusted to give the desired temperature of 20°-25° C. in the ultrasonic bath. Simultaneous pumping of the feed solutions was started at the desired flow rate and maintained to flush the lines with reactant solutions and start production. The initial 50 ml of CaF₂ (doped or undoped) nanoparticle slurry product was directed to a waste container. Without interrupting the pumping, the product output line was switched to a product collection bottle and the reaction was run until approximately 100-120 ml of the doped or undoped CaF₂ nano-particle suspension was accumulated.

The cloudy as-made suspension was purified to remove soluble ammonium nitrate salts by dialysis. After dialysis, the purified metal fluoride nano-particle suspension was ultrasonically agitated for 5 min using a 0.25 inch diameter microprobe attached to a Branson™ Digital Sonifier (model 450). During ultrasonic agitation, the vessel containing the product doped or undoped CaF₂ nano-particle suspension was cooled in a water-ice bath. After ultrasonic agitation, a sample of the purified product was diluted with deionized water to contain 0.25-1.0 wt % of the nano-particles and the effective diameter of the nano-particles was measured by light scattering.

### Dialysis Purification of Product

Tubular dialysis membranes (Spectra Por™ Molecular Porous Membrane Tubing, 29 mm diameter, 45 mm flat width, MWCO=12-14,000 da, capacity=6.4 ml/cm of length) sold by Spectrum Laboratories were used to purify the doped or undoped CaF₂ suspension.

A 22 cm long strip of dialysis tubing was immersed and soaked in deionized water to soften the tubing. One end of the tubing was sealed with a plastic clamp and 100 ml of nano-particle suspension was poured into the other end which was then likewise sealed. The filled dialysis tube was then suspended vertically and fully immersed in a water bath comprised of a 5 liter plastic beaker that was filled with deionized water with stirring by a magnetic stirring bar. Several (1-6) such tubes could be simultaneously so immersed in the same water bath. The bath water was exchanged with fresh deionized water approximately every two hours on the first day of the dialysis process. On subsequent days of the dialysis process, the bath water was exchanged with fresh deionized water three times during an 8 hr period, in the morning, at noon, and in the evening. The dialysis process was continued thus for several days. On the fourth day of the dialysis process and each day afterward, the conductivity of the nano-particle suspension within the dialysis tubing was measured using the method described infra, and noted. The dialysis process was continued until the conductivity of the nano-particle suspension within the dialysis tubing stopped decreasing and reached a steady state. At this point the process was deemed complete and the purified nano-particle suspension was transferred from the dialysis tubing into a glass container and sealed for storage.

### Conductivity Measurement

The conductivity of aqueous solutions and aqueous nano-particle suspensions was measured using a VWR™ model 4063 conductivity meter equipped with a model 4061 epoxy probe. The conductivity meter was calibrated, in accord with it's written instructions, at three points with solutions of known conductivity. The three solutions of known conductivity were VWR™ brand Traceable Conductivity Standards at values, 1.75 μS/cm (catalog number 36934-134), 8.94 μS/cm (catalog number 23226-567), and 98.5 μS/cm (catalog number 23226-589).

To measure conductivity, the probe was first rinsed with deionized water (18.0 MOhm deionized water from a Barnstead NanoPure™ model D4741 water purifier, filtered 0.2μ at delivery) then blown dry with a stream of nitrogen. The probe was then immersed in the target liquid and moved around to stir the liquid. The conductivity of the liquid was read from the digital display of the conductivity meter.

### Particle Size Analysis

For particle size analysis, an aliquot of the suspension was diluted in water to 0.25-1.0 wt-% solids content. Particle size was then measured using a Brookhaven Instruments BI200SM goniometer set at 90 degrees scattering angle. The incident light was a 50 mW Melles Griot He—Ne laser (632.8 nm wavelength). The pinhole was typically set to 400 microns. An interference filter with a narrow bandpass at 632.8 nm was used to eliminate any extraneous light. Photon counts were acquired using a Brookhaven Instruments BI-APD avalanche photodiode. The auto-correlation function was acquired with a Brookhaven Instruments BI2030 auto-correlator. The analysis software used was the Particle Sizing software from Brookhaven Instruments.

To measure particle size, the sample holder was rinsed with filtered deionized water and blown dry with a stream of filtered nitrogen. The nano-particle suspension was charged to the sample holder, placed in the instrument chamber and allowed to thermally equilibrate (25° C.). For each sample, five analysis runs of five minutes each were acquired. The cumulative correlation function was fit with the method of cumulants to obtain the z-average diffusion coefficient and normalized second cumulant (polydispersity term). The z-average diffusion coefficient was converted to the AESD of the nano-particles using the Stokes-Einstein expression and where the viscosity of water is assigned as 0.955 cP.

### Example 2

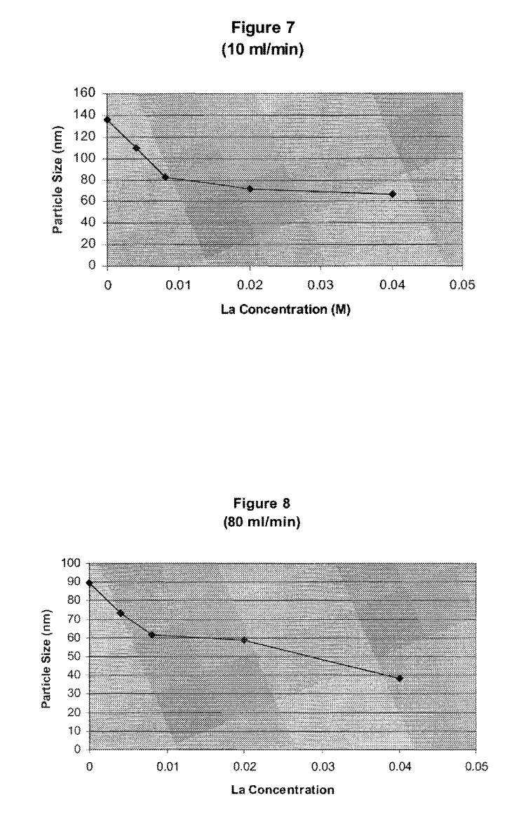

A series of five La-doped CaF₂ nano-particles was prepared according to the methods described supra. La(NO₃)₃ and Ca(NO₃)₂ were prepared and combined in aqueous solution in the amounts shown in Tables 4 and 5 for Examples 2-1, 2-2, 2-3, 2-4, and 2-5 according to the procedures described supra. The flow rate of both feed streams was set at 10 ml/min. Sensitivity (nm/mol) of particle size to molar concentration of La³⁺ is shown in Table 6, and graphically represented in FIG. 7.

TABLE 6
(10 ml/min)

| | | | |
|---|---|---|---|
| | Concentration | | |
| | of La³⁺ | AESD | Sensitivity |
| Example | (M) | (nm) | (nm/mol - La³⁺⁾ |

| | | | |
|---|---|---|---|
| 2-1 | 0 | 135 | 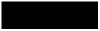 |
| 2-2 | 0.004 | 109 | 6500 |
| 2-3 | 0.008 | 83 | 6675 |
| 2-4 | 0.02 | 71 | 967 |
| 2-5 | 0.04 | 66 | 235 |

### Example 3

The materials and procedures of Example 2 were employed except that the flow rate of the feed streams was 80 ml/min. Sensitivity (nm/mol) of particle size to molar concentration of La³⁺ is shown in Table 7, and graphically represented in FIG. 8.

TABLE 7
(80 ml/mm)

| | Concentration | | Sensitivity |
|---|---|---|---|
| | of La³⁺ | AESD | (nm/mol - |
| Example | (M) | (nm) | La³⁺⁾ |
| 3-1 | 0 | 89.7 | 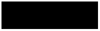 |
| 3-2 | 0.004 | 73.1 | 4150 |
| 3-3 | 0.008 | 61.8 | 2825 |
| 3-4 | 0.02 | 58.8 | 250 |
| 3-5 | 0.04 | 38.2 | 1030 |

### Examples 4 and 5

Eu(NO₃)₃ and Ca(NO₃)₂ were prepared and combined in aqueous solution in the amounts shown in Tables 4 and 5 for Examples 4-1, 4-2, 5-1 and 5-2 according to the procedures described supra. Sensitivity (nm/mol) of particle size to molar concentration of Eu³⁺ is shown in Table 8 for 10 ml/min and 80 ml/min flow rates.

TABLE 8

| | feed | | | |
|---|---|---|---|---|
| | stream | Concentration | Particle | |
| | flow rate | of Eu³⁺ | Size | Sensitivity |
| Specimen | (ml/min) | (M) | (nm) | (nm/mol) |
| 4-1 | 10 | 0 | 164 | 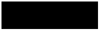 |
| 4-2 | 10 | 0.02 | 55 | 5450 |
| 5-1 | 80 | 0 | 122 | 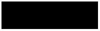 |
| 5-2 | 80 | 0.02 | 44 | 3900 |

### Examples 6-8

La(NO₃)₃ and Ca(NO₃)₃ were prepared and combined in aqueous solution in the amounts shown in Tables 4 and 5 for Examples 6, 7, and 8 according to the procedures described supra. The flow rate of both feed streams was set at 10 ml/min. The reagents were combined in the non-stoichiometric molar ratios as shown in Table 7. In Example 6, there is a small excess of cation. In Example 7 there is exact stoichiometric balance. In Example 8 there is a small excess of fluoride. Particle size results are shown in Table 9.

TABLE 9

| | Feed Stream | | | Particle |
|---|---|---|---|---|
| | Flow Rate | Cation | Fluoride | Size |
| Example | (ml/min) | Normality | Normality | (nm) |
| 6-1 | 10 | 0.86 | 0.8 | 40 |
| 6-2 | 80 | 0.86 | 0.8 | 32 |
| 7-1 | 10 | 0.82 | 0.82 | 61 |
| 7-2 | 80 | 0.82 | 0.82 | 33 |
| 8-1 | 10 | 0.86 | 0.92 | 65 |
| 8-2 | 80 | 0.86 | 0.92 | 39 |

### Comparative Examples B-D

Undoped calcium fluoride nano-particle dispersions were made according to the procedure of Example 2. The concentration of the reagent solutions are those shown in Tables 4 and 5 for Examples BCD, the reaction flow rates, and the effective diameter of the nano-particles are tabulated in Table 10.

TABLE 10

| | | | Feed | | |
|---|---|---|---|---|---|
| | | | Stream | | |
| Com- | Ca(NO₃)₂ | NH₄F | Flow | Particle | Sensitivity |
| parative | Molarity | Molarity | Rate | Size | (nm/mol- |
| Example | (M) | (M) | (ml/mm) | (nm) | Ca²⁺⁾ |
| B-1 | 0.2 | 0.4 M | 10 | 208.4 | 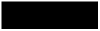 |
| B-2 | 0.4 | 0.8 M | 10 | 163.7 | 223.5 |
| B-3 | 0.8 | 1.6 M | 10 | 135.4 | 70.75 |
| B-4 | 1.2 | 2.4 M | 10 | 115.4 | 50 |
| C-1 | 0.2 | 0.4 M | 40 | 141.5 | 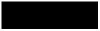 |
| C-2 | 0.4 | 0.8 M | 40 | 126.4 | 75.5 |
| C-3 | 0.8 | 1.6 M | 40 | 91.4 | 87.5 |
| C-4 | 1.2 | 2.4 M | 40 | 86.5 | 12.25 |
| D-1 | 0.2 | 0.4 M | 80 | 129.3 | 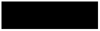 |
| D-2 | 0.4 | 0.8 M | 80 | 121.7 | 38 |
| D-3 | 0.8 | 1.6 M | 80 | 89.7 | 80 |
| D-4 | 1.2 | 2.4 M | 80 | 84.5 | 13 |

What is claimed is:

1. A method comprising
preparing a plurality of reactive precipitations wherein each reactive precipitation comprises combining
a first aqueous solution of a fluoride selected from the group consisting of alkali metal fluorides, ammonium fluoride, hydrogen fluoride, and mixtures thereof at a concentration in the range of 0.1 normal to 3 normal;
a second aqueous solution of a Group 2 or Group 3 metal salt comprising a Group 2 or Group 3 metal cation at a concentration in the range of 0.1 normal to 3 normal; and,
a third aqueous solution of a rare-earth metal dopant salt comprising a a rare-earth metal dopant cation wherein the concentration of the rare-earth metal cation is in the range of 0.5 to 25 mol-% of the molar concentration of said Group 2 or Group 3 metal cation; and, wherein the concentration of the rare-earth metal dopant cation is in the range of 0.0005 to 0.75 normal with respect to the combined volumes of the second and third aqueous solutions;
thereby,
forming a precipitate of a rare-earth doped aqueously insoluble Group 2 or Group 3 metal fluoride characterized by an average equivalent spherical diameter in the range of 2 to 200 nm and a rare-earth dopant concentration of 0.5 to 25 mol-%, with respect to the concentration of said Group 2 or Group 3 metal, said aqueously insoluble fluoride being characterized by an aqueous solubility of less than 0.1 g/100 g of water;
and,
wherein each reactive precipitation differs from the others by the concentration of the rare-earth metal dopant cation with respect to the combined volumes of the second and third aqueous solutions,
thereby determining the dependency of the average equivalent spherical diameter of the nanoscale rare-earth-doped Group 2 or Group 3 metal fluoride on the concentration of the rare-earth metal dopant cation;
and,
preparing at least one additional the reactive precipitation at a rare-earth-dopant concentration selected to provide a desired particle size.

2. The method of claim 1 wherein the Group 2 or Group 3 metal cation is selected from the group consisting of Ca²⁺, Mg²⁺, Sr²⁺, Y³⁺, La³⁺, Ac³⁺, Cr³⁺, Mo³⁺, Ir³⁺, Cu²⁺, Ga³⁺, Pb²⁺, Ce³⁺, Nd³⁺, Eu³⁺, Er³⁺, Yb³⁺, and Lu³⁺.²⁺

3. The method of claim 2 wherein the Group 2 or Group 3 metal cation is selected from the group consisting of Ca²⁺ or La³⁺.

4. The method of claim 1 wherein the aqueous solution of a fluoride is an aqueous ammonium fluoride solution.

5. The method of claim 1 further comprising purification of the aqueously insoluble rare-earth doped Group 2 or Group 3 metal fluoride by membrane dialysis.

6. The method of claim 1 wherein the normality of the aqueous fluoride and Group 2 or Group 3 metal salt solutions are equal.

7. The method of claim 1 wherein the fluoride and Group 2 or Group 3 metal and the rare-earth dopant are combined in stoichiometric amounts.

8. The method of claim 1 in the form of a batch process.

9. The method of claim 1 in the form of a continuous process.

10. The method of claim 1 further comprising combining the second aqueous solution and the third aqueous solution before combining with the first aqueous solution.
